(19) United States
(12) Patent Application Publication
(10) Pub. No.: US 2016/0208954 A1
(43) Pub. Date: Jul. 21, 2016

(54) VALVE DEVICE

(71) Applicant: KAWASAKI JUKOGYO KABUSHIKI KAISHA, Kobe-shi, Hyogo (JP)

(72) Inventors: Noboru ITO, Kobe-shi (JP); Makoto NINOMIYA, Kobe-shi (JP); Kaoru NOMICHI, Ono-shi (JP); Kodai KATOH, Kakogawa-shi (JP); Katsu YOSHIDA, Kakogawa-shi (JP)

(73) Assignee: KAWASAKI JUKOGYO KABUSHIKI KAISHA, Kobe-shi, Hyogo (JP)

(21) Appl. No.: 14/914,200

(22) PCT Filed: Aug. 21, 2014
(86) PCT No.: PCT/JP2014/004312

§ 371 Date: Feb. 24, 2016

(30) Foreign Application Priority Data
Sep. 3, 2013 (JP) 2013-181910

(51) Int. Cl. F16K 39/02; F16K 31/06

(52) U.S. Cl. CPC F16K 39/024; F16K 31/0665

(57) ABSTRACT

A valve device includes main valve element and pilot valve element. The main valve element divides valve element space of housing into first pressure chamber and second pressure chamber. The pilot valve element is provided in the second pressure chamber. In one example, first pilot passage including first restrictor extends from primary passage to the second pressure chamber, and second pilot passage including second restrictor is formed at the main valve element. The main valve element and the pilot valve element are coupled to each other by pin, and gap is formed between the pin and one of the main valve element and the pilot valve element. The pilot valve element opens and closes the second pilot passage by biasing member and drive mechanism. The main valve element is driven so as to open the secondary passage by differential pressure between the first pressure chamber and the second pressure chamber.

### TECHNICAL FIELD

The present invention relates to a valve device used as, for example, a pneumatic controller or a stopper for a gas tank.

### BACKGROUND ART

For example, known as a valve device that operates under a high-pressure condition is a device including: a main valve element that blocks and opens a main passage formed at a housing; and a pilot valve element that controls opening/closing operations of the main valve element. For example, PTL 1 discloses a valve device in which a main valve element and a pilot valve element are arranged coaxially.

FIG. 8 shows a part of a valve device 100 disclosed in PTL 1. A primary passage 121, a pressure chamber 122, and a secondary passage 123 are formed at a housing 110 of the valve device 100. The primary passage 121, the pressure chamber 122, and the secondary passage 123 constitute a main passage 120. The secondary passage 123 is opened and closed by a main valve element 140. A pilot chamber 130 is formed on an opposite side of the pressure chamber 122 across the main valve element 140. The pilot chamber 130 communicates with the pressure chamber 122 through a first pilot passage 131 that is a gap between the main valve element 140 and the housing 110. A second pilot passage 132 is formed at the main valve element 140 and is opened and closed by a pilot valve element 150. The pilot valve element 150 is driven by a solenoid (not shown).

Further, in the valve device 100, the main valve element 140 and the pilot valve element 150 are coupled to each other by a pin 160. The pin 160 is fitted in a transverse hole of the pilot valve element 150 without any gap. However, a gap is formed between the pin 160 and a support hole 141 of the main valve element 140, and therefore, the pilot valve element 150 can be separated from the main valve element 140 by the gap.

The pilot valve element 150 is pressed against the main valve element 140 by a spring (not shown). When a current flows through the solenoid (not shown), the pilot valve element 150 is first separated from the main valve element 140 by the gap between the support hole 141 and the pin 160. Thus, the second pilot passage 132 is opened. Then, when differential pressure between the pilot chamber 130 and the secondary passage 123 becomes low, and attractive force of the solenoid attracting the pilot valve element 150 exceeds biasing force of the spring biasing the pilot valve element 150 and pressure of the pilot chamber 130, the main valve element 140 is pulled upward. Thus, the secondary passage 123 is opened.

### CITATION LIST

### Patent Literature

PTL 1: Japanese Laid-Open Patent Application Publication No. 8-75029

### SUMMARY OF INVENTION

### Technical Problem

However, according to a configuration in which the main valve element 140 is driven in an open direction by the attractive force of the solenoid as in the valve device 100 disclosed in PTL 1, some amount of time is required until the attractive force of the solenoid exceeds the biasing force of the spring biasing the pilot valve element 150 and the pressure of the pilot chamber 130. Thus, responsiveness of the above configuration is not good. Further, since the solenoid has to have high attractive force for pulling up the main valve element 140, it is difficult to reduce the size of the solenoid.

An object of the present invention is to provide a valve device in which a drive mechanism for a pilot valve element can be reduced in size and which has excellent responsiveness.

### Solution to Problem

To achieve the above object, a valve device according to the present invention includes: a housing including a primary passage, a secondary passage, and a valve element space between the primary passage and the secondary passage, the primary passage and the secondary passage constituting a main passage; a main valve element provided in the housing so as to divide the valve element space into a first pressure chamber and a second pressure chamber, the main valve element being configured to open and close the secondary passage, the first pressure chamber communicating with the primary passage and the secondary passage; a first pilot passage including one end directly or indirectly communicating with the primary passage, the other end communicating with the second pressure chamber, and a first restrictor; a second pilot passage including a second restrictor and formed at the main valve element so as to extend from the second pressure chamber to the secondary passage; a pilot valve element provided in the second pressure chamber and configured to open and close the second pilot passage; a biasing member configured to press the pilot valve element against the main valve element; a drive mechanism configured to, when a current flows through the drive mechanism, drive the pilot valve element such that the pilot valve element opens the second pilot passage against biasing force of the biasing member; and a pin coupling the main valve element and the pilot valve element to each other, a gap which allows the pilot valve element to be separated from the main valve element being formed between the pin and the main valve element or between the pin and the pilot valve element, wherein when the second pilot passage is opened by the pilot valve element, and pressure of the second pressure chamber becomes lower than pressure of the first pressure chamber, the main valve element is driven so as to open the secondary passage by differential pressure between the first pressure chamber and the second pressure chamber.

According to the above configuration, the main valve element is driven in an open direction by the differential pressure between the first pressure chamber and the second pressure chamber. Therefore, when the second pilot passage is opened by the pilot valve element, the main valve element instantly performs an open operation by a decrease in pressure of the second pressure chamber. On this account, the valve device has excellent responsiveness. In addition, the drive mechanism for the pilot valve element is only required to have power necessary to drive the pilot valve element by the gap between the pin and the main valve element or between the pin and the pilot valve element. Therefore, the drive mechanism can be reduced in size. Further, since the second pilot passage including the second restrictor is formed at the main valve element, an area of the valve seat for the pilot valve element can be reduced, and the open operation of the pilot valve element can be performed by smaller driving power. Furthermore, since the main valve element and the pilot valve element are coupled to each other by the pin, the open state of the secondary passage by the main valve element can be maintained by utilizing the power of the drive mechanism.

The valve device may be configured such that: the drive mechanism is a solenoid including a fixed magnetic pole configured to attract the pilot valve element; the housing is provided with a stopper for the main valve element; and when the second pilot passage and the secondary passage are closed, a distance from the pilot valve element to the fixed magnetic pole is longer than a sum of a distance from the main valve element to the stopper and the gap. According to this configuration, while a current flows through the solenoid, the main valve element can be pressed against the stopper by attractive force of the solenoid.

The valve device may be configured such that the first pilot passage is formed at the housing or the main valve element. According to this configuration, the first restrictor can be formed by machine work with a high degree of accuracy.

Or, the valve device may be configured such that: the housing includes a sliding chamber configured to hold the main valve element such that the main valve element is slidable; and the first pilot passage is a gap between the main valve element and the sliding chamber and serves as the first restrictor over an entire length of the first pilot passage. According to this configuration, the first pilot passage and the first restrictor can be simply configured at low cost.

### Advantageous Effects of Invention

The present invention can provide a valve device in which a drive mechanism for a pilot valve element can be reduced in size and which has excellent responsiveness.

### BRIEF DESCRIPTION OF DRAWINGS

FIG. 1 is a schematic configuration diagram of a valve device according to Embodiment 1 of the present invention and shows a state where a main passage is blocked by a main valve element.

FIG. 2 shows a state where the main passage is opened by the main valve element in the valve device of Embodiment 1.

FIG. 3 is a schematic configuration diagram of the valve device according to Embodiment 2 of the present invention.

FIG. 4 is a schematic configuration diagram of the valve device according to Embodiment 3 of the present invention.

FIG. 5 is a schematic configuration diagram of the valve device according to Modification Example of Embodiment 3.

FIG. 6 is a schematic configuration diagram of the valve device according to Embodiment 4 of the present invention.

FIG. 7 is a schematic configuration diagram of the valve device according to Embodiment 5 of the present invention.

FIG. 8 is a cross-sectional view of a part of a conventional valve device.

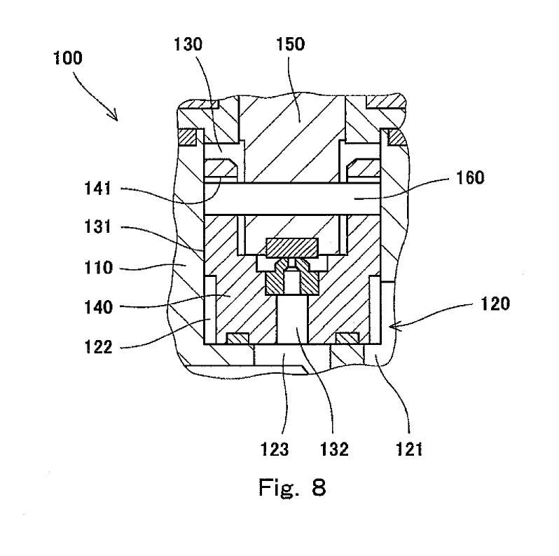

### DESCRIPTION OF EMBODIMENTS

### Embodiment 1

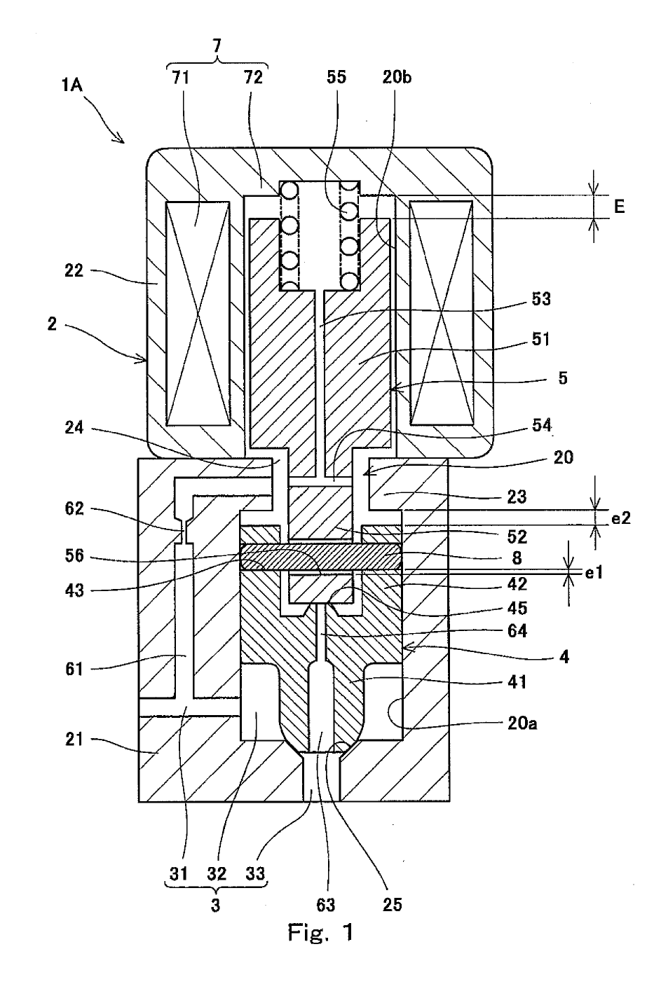

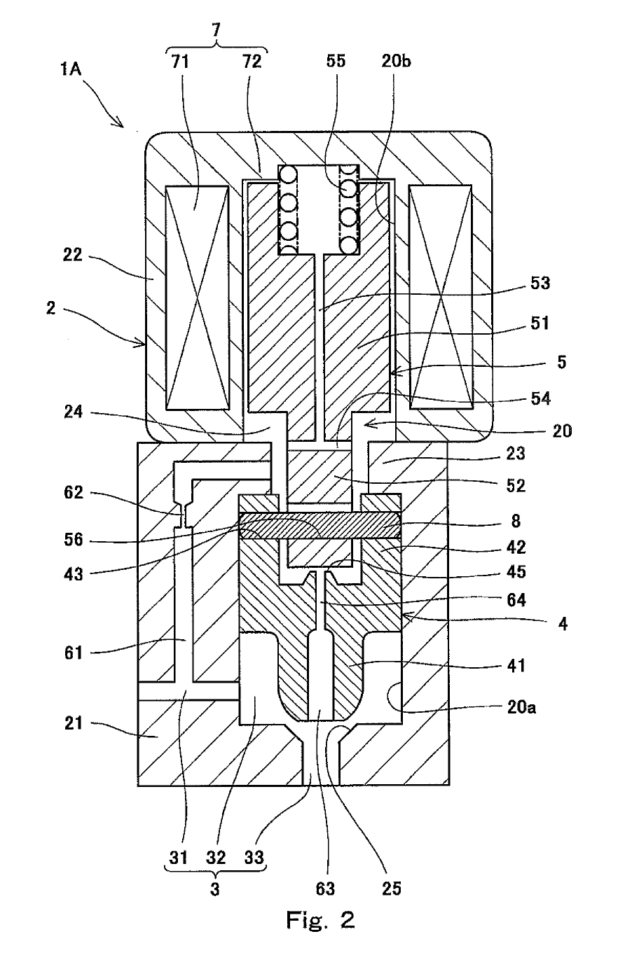

FIGS. 1 and 2 show a valve device 1A according to Embodiment 1 of the present invention. The valve device 1A is used as a pneumatic controller, a stopper for a gas tank, or the like. A fluid intended for the valve device 1A is, for example, a high-pressure gas.

The valve device 1A of the present embodiment is a solenoid valve. Specifically, the valve device 1A includes a housing 2, a main valve element 4 and pilot valve element 5 provided in the housing 2, and a solenoid (drive mechanism) 7 configured to drive the pilot valve element 5. When the valve device 1A is used as the stopper for the gas tank, almost whole of the valve device 1A including the solenoid 7 may be inserted in the gas tank.

However, the valve device 1A is not limited to the solenoid valve adopting the solenoid 7 as the drive mechanism. For example, a piezoelectric actuator may be used as the drive mechanism. The piezoelectric actuator includes a piezoelectric element (piezo element) and generates driving force corresponding to an applied voltage. Or, a force motor may be used as the drive mechanism. The force motor is configured such that a movable coil is inserted into a cylindrical permanent magnet. When a current flows through the movable coil, magnetizing force corresponding to the current is generated, and the movable coil moves by this magnetizing force.

Each of the main valve element 4 and the pilot valve element 5 is a rod-shaped member having a circular cross section. A central axis of the main valve element 4 and a central axis of the pilot valve element 5 are located on the same straight line. In other words, the main valve element 4 and the pilot valve element 5 are coaxially provided. Hereinafter, for convenience of explanation, a direction in which the main valve element 4 and the pilot valve element 5 are lined up (i.e., an axial direction of each of the main valve element 4 and the pilot valve element 5) is referred to as an upward/downward direction (the pilot valve element 5 side is an upper side, the main valve element 4 side is a lower side). However, needless to say, the direction in which the main valve element 4 and the pilot valve element 5 are lined up may be a horizontal direction or an oblique direction.

The housing 2 includes a first main body 21 and a second main body 22. A primary passage 31 and a secondary passage 33 are formed at the first main body 21 and constitute a main passage 3, and the solenoid 7 is incorporated in the second main body 22. The housing 2 further includes a valve element space 20 between the primary passage 31 and the secondary passage 33. The valve element space 20 extends in both the first main body 21 and the second main body 22.

More specifically, the first main body 21 includes a cylindrical first sliding chamber 20a which holds the main valve element 4 such that the main valve element 4 is slidable in the upward/downward direction. The second main body 22 includes a cylindrical second sliding chamber 20b which holds the pilot valve element 5 such that the pilot valve element 5 is slidable in the upward/downward direction. The first main body 21 includes a stopper 23 which is located between the first sliding chamber 20a and the second sliding chamber 20b, projects in a radially inward direction, and contacts the upwardly-moving main valve element 4 to stop the main valve element 4. The valve element space 20 is a continuous space defined by the first sliding chamber 20a, the stopper 23, and the second sliding chamber 20b.

One end (upstream end) of the primary passage 31 opens on a side surface of the first main body 21, and the other end (downstream end) of the primary passage 31 opens on a peripheral surface of the first sliding chamber 20a. One end (upstream end) of the secondary passage 33 opens on a bottom surface of the first sliding chamber 20a, and the other end (downstream end) of the secondary passage 33 opens on a lower surface of the first main body 21. A first valve seat 25 for the main valve element 4 is formed at the bottom surface of the first sliding chamber 20a so as to be located around the upstream end of the secondary passage 33.

The main valve element 4 is provided in the housing 2 so as to divide the valve element space 20 into a first pressure chamber 32 and a second pressure chamber 24. The first pressure chamber 32 communicates with the primary passage 31 and the secondary passage 33. The first pressure chamber 32 constitutes the main passage 3 together with the primary passage 31 and the secondary passage 33.

More specifically, the main valve element 4 includes a shaft portion 41 and a tubular portion 42. The shaft portion 41 is smaller in diameter than the peripheral surface of the first sliding chamber 20a. The tubular portion 42 extends upward from an upper peripheral portion of the shaft portion 41 and has an outer diameter substantially equal to the diameter of the peripheral surface of the first sliding chamber 20a. The tubular portion 42 is held by the first sliding chamber 20a so as to be slidable. To be specific, the first pressure chamber 32 is defined between an outer peripheral surface of the shaft portion 41 and a portion of the peripheral surface of the first sliding chamber 20a, the portion being located below the tubular portion 42. The second pressure chamber 24 is constituted by: a space facing an upper surface of the shaft portion 41 and an inner peripheral surface of the tubular portion 42; a region of the first sliding chamber 20a, the region being located above the main valve element 4; an inside of the stopper 23; and the second sliding chamber 20b. To isolate the first pressure chamber 32 and the second pressure chamber 24 from each other between the peripheral surface of the first sliding chamber 20a and the main valve element 4, a sealing member (not shown) may be attached to the tubular portion 42.

The main valve element 4 moves between a closed position where the shaft portion 41 is seated on the first valve seat 25 and an open position where the tubular portion 42 contacts the stopper 23. Thus, the main valve element 4 opens and closes the secondary passage 33. When the shaft portion 41 is seated on the first valve seat 25, the secondary passage 33 is closed, and the first pressure chamber 32 is isolated from the secondary passage 33. When the shaft portion 41 is separated from the first valve seat 25, the secondary passage 33 is opened, and the first pressure chamber 32 is connected to the secondary passage 33.

In the present embodiment, a first pilot passage 61 is formed at the first main body 21 of the housing 2. One end (upstream end) of the first pilot passage 61 directly communicates with the primary passage 31, and the other end (downstream end) of the first pilot passage 61 communicates with the second pressure chamber 24. A first restrictor 62 is provided at an intermediate portion of the first pilot passage 61.

A second pilot passage 63 is formed at the main valve element 4 so as to extend from the second pressure chamber 24 to the secondary passage 33. The second pilot passage 63 is located on the central axis of the main valve element 4. One end (upstream end) of the second pilot passage 63 opens on the upper surface of the shaft portion 41, and the other end (downstream end) of the second pilot passage 63 opens on a tip end surface of the shaft portion 41. A second restrictor 64 is provided at an end portion of the second pilot passage 63, the end portion being located at the second pressure chamber 24 side. The second pilot passage 63 is opened and closed by the pilot valve element 5.

The pilot valve element 5 is provided in the second pressure chamber 24. A biasing member 55 configured to press the pilot valve element 5 against the main valve element 4 is provided in the second pressure chamber 24. The first biasing member 55 is, for example, a compression coil spring.

To prevent the second pressure chamber 24 from being completely separated into upper and lower spaces by the pilot valve element 5, the pilot valve element 5 includes a longitudinal hole 53 located on the central axis and a transverse hole 54 intersecting with a lower end of the longitudinal hole 53. In the second pressure chamber 24, a space at a lower side of the pilot valve element 5 and a space at an upper side of the pilot valve element 5 communicate with each other through the longitudinal hole 53 and the transverse hole 54.

More specifically, the pilot valve element 5 includes: a main body portion 51 held by the second sliding chamber 20b so as to be slidable; and a shaft portion 52 projecting downward from the main body portion 51 to be inserted into the tubular portion 42 of the main valve element 4.

A second valve seat 45 for the pilot valve element 5 is formed on the upper surface of the shaft portion 41 of the main valve element 4 so as to be located around the upstream end of the second pilot passage 63. When the shaft portion 52 is seated on the second valve seat 45, the second pilot passage 63 is closed, and the second pressure chamber 24 is isolated from the second pilot passage 63. When the shaft portion 52 is separated from the second valve seat 45, the second pilot passage 63 is opened, and the second pressure chamber 24 is connected to the second pilot passage 63. In the second pressure chamber 24, when the shaft portion 52 of the pilot valve element 5 is separated from the second valve seat 45, a fluid is introduced to the upstream end of the second pilot passage 63 through a gap between the inner peripheral surface of the tubular portion 42 of the main valve element 4 and an outer peripheral surface of the shaft portion 52 of the pilot valve element 5 and a gap between the upper surface of the shaft portion 41 of the main valve element 4 and a tip end surface of the shaft portion 52 of the pilot valve element 5.

When a current flows through the solenoid 7, the solenoid 7 drives the pilot valve element 5 such that the pilot valve element 5 opens the second pilot passage 63 against the biasing force of the biasing member 55. To be specific, the pilot valve element 5 also serves as a movable core driven by the solenoid 7. The solenoid 7 includes: a coil 71 wound around the second sliding chamber 20b; and a fixed magnetic pole 72 provided above the pilot valve element 5 and configured to attract the pilot valve element 5. The fixed magnetic pole 72 is also a part of the second main body 22 of the housing 2.

The shaft portion 52 of the pilot valve element 5 and the tubular portion 42 of the main valve element 4 are coupled to each other by a pin 8 extending in a horizontal direction orthogonal to the upward/downward direction. A transverse hole 56 into which the pin 8 is inserted is formed at the shaft portion 52 of the pilot valve element 5. A support hole 43 which supports both end portions of the pin 8 is formed at the tubular portion 42 of the main valve element 4. In the present embodiment, the pin 8 is fitted in the support hole 43 without any gap. When the pilot valve element 5 is in contact with the main valve element 4, a gap e1 between the pin 8 and the transverse hole 56 is formed under the pin 8. Therefore, the pilot valve element 5 can be separated from the main valve element 4 by the gap e1 (see FIG. 2). The transverse hole 56 may be a circular hole having a larger diameter than the pin 8 or may be an elongated hole having a width equal to the diameter of the pin 8 and extending in the upward/downward direction.

When the second pilot passage 63 is in a closed state, pressure Pr of the second pressure chamber 24 is equal to primary pressure P1 that is pressure of the primary passage 31. To move the pilot valve element 5 by the gap e1, the solenoid 7 has attractive force Fc higher than force represented by Fs+Ap(P1−P2) where P2 denotes secondary pressure that is pressure of the secondary passage 33, Ap denotes an area of the second valve seat 45, and Fs denotes the biasing force of the biasing member 55.

When the second pilot passage 63 is opened by the pilot valve element 5, and the pressure of the second pressure chamber 24 becomes lower than the pressure of the first pressure chamber 32, the main valve element 4 is driven so as to open the secondary passage 33 by differential pressure between the first pressure chamber 32 and the second pressure chamber 24. Specifically, the first restrictor 62, the second restrictor 64, and areas A1 and Am are set so as to satisfy a formula “(P1−Pr)(A1−Am)>(Pr−P2)Am” where A1 denotes a cross-sectional area of the first sliding chamber 20a, and Am denotes an area of the first valve seat 25.

Next, operations of the valve device 1A will be explained. The following explanation starts from a state where the main valve element 4 is located at the closed position as shown in FIG. 1.

When a current does not flow through the solenoid 7, the pilot valve element 5 is pressed against the main valve element 4 by the biasing member 55, and therefore, the second pilot passage 63 is closed. To be specific, pressure of the second pilot passage 63 is equal to the secondary pressure P2, and pressure of the first pilot passage 61 and the second pressure chamber 24 is equal to the primary pressure P1. Therefore, the shaft portion 52 of the pilot valve element 5 is pressed against the second valve seat 45 by biasing force Fs of the biasing member 55 and pressing force (Ap(P1−P2)) corresponding to differential pressure between the second pressure chamber 24 and the second pilot passage 63. The shaft portion 41 of the main valve element 4 is pressed against the first valve seat 25 by the biasing force Fs of the biasing member 55 and pressing force (Am(P1−P2)) corresponding to differential pressure between the second pressure chamber 24 and the secondary passage 33.

When a current flows through the solenoid 7, first, the pilot valve element 5 moves upward by the gap e1 by the attractive force Fe of the solenoid 7. With this, the second pilot passage 63 is opened, and the fluid flows from the primary passage 31 through the first pilot passage 61, the second pressure chamber 24, and the second pilot passage 63 to the secondary passage 33. As a result, the pressure Pr of the second pressure chamber 24 decreases to pressure between the primary pressure P1 and the secondary pressure P2, and the main valve element 4 moves upward by the differential pressure between the first pressure chamber 32 and the second pressure chamber 24. With this, the secondary passage 33 is opened.

The main valve element 4 moves upward until the main valve element 4 contacts the stopper 23. In accordance with the upward movement of the main valve element 4, the pilot valve element 5 coupled to the main valve element 4 by the pin 8 also moves upward by the attractive force Fc of the solenoid 7.

In the present embodiment, a distance E from the pilot valve element 5 to the fixed magnetic pole 72 when the second pilot passage 63 and the secondary passage 33 are closed is set to be longer than a sum of the gap e1 which allows the pilot valve element 5 to be separated from the main valve element 4 and a distance e2 from the main valve element 4 to the stopper 23 (E>e1+e2). Therefore, even when the main valve element 4 contacts the stopper 23, a gap is secured between the pilot valve element 5 and the fixed magnetic pole 72 as shown in FIG. 2. In other words, the main valve element 4 can be pressed against the stopper 23 by the attractive force Fc of the solenoid 7. Therefore, even if the supply of the fluid is stopped at a downstream side of the valve device 1A, and the fluid does not flow through the main passage 3, the main valve element 4 can be restricted to the open position while a current flows through the solenoid 7. The gap e1 which allows the pilot valve element 5 to be separated from the main valve element 4 is much smaller than the distance e2 that is a stroke of the main valve element 4.

When the flow of the current through the solenoid 7 is cut, the pilot valve element 5 first closes the second pilot passage 63 by the biasing force Fs of the biasing member 55. With this, the pressure Pr and the pressure P1 become equal to each other, and the main valve element 4 moves from the open position to the closed position by the biasing force Fs of the biasing member 55 and the differential pressure between the second pressure chamber 24 and the secondary passage 33.

As explained above, according to the valve device 1A of the present embodiment, the main valve element 4 is driven in an open direction by the differential pressure between the first pressure chamber 32 and the second pressure chamber 24. Therefore, when the second pilot passage 63 is opened by the pilot valve element 5, the main valve element 4 instantly performs an open operation by a decrease in the pressure of the second pressure chamber 24. On this account, the valve device 1A has excellent responsiveness. In addition, the solenoid 7 for the pilot valve element 5 is only required to have the attractive force necessary to move the pilot valve element 5 by the gap e1 between the pin 8 and the pilot valve element 5. Therefore, the solenoid 7 can be reduced in size. Further, since the second pilot passage including the second restrictor 64 is formed at the main valve element 4, an area of the valve seat for the pilot valve element 5 can be reduced, and the open operation of the pilot valve element 5 can be performed by smaller driving power. Furthermore, since the main valve element 4 and the pilot valve element 5 are coupled to each other by the pin 8, the open state of the secondary passage 33 by the main valve element 4 can be maintained by utilizing the attractive force of the solenoid 7.

### Modification Example

In the above embodiment, the distance E from the pilot valve element 5 to the fixed magnetic pole 72 is set to be longer than the sum of the gap e1 which allows the pilot valve element 5 to be separated from the main valve element 4 and the distance e2 from the main valve element 4 to the stopper 23 (E>e1+e2). However, even in a case where the distance E is equal to or shorter than the sum of the gap e1 and the distance e2 (including a case where the distance e2 is equal to or longer than the distance E and a case where the stopper 23 is not provided), the pilot valve element 5 contacts the fixed magnetic pole 72 by the flow of the current through the solenoid 7, and the main valve element 4 coupled to the pilot valve element 5 by the pin 8 can be maintained at the open position. However, in this state, the position of the main valve element 4 may change by a slight gap between the pin 8 and the transverse hole 56. In contrast, when the distance E is longer than the sum of the gap e1 and the distance e2, the attractive force Fe of the solenoid 7 can be caused to act on the main valve element 4 located at the open position. With this, the position of the main valve element 4 can be prevented from changing. The present modification example is applicable to Embodiments 2 to 5 below.

### Embodiment 2

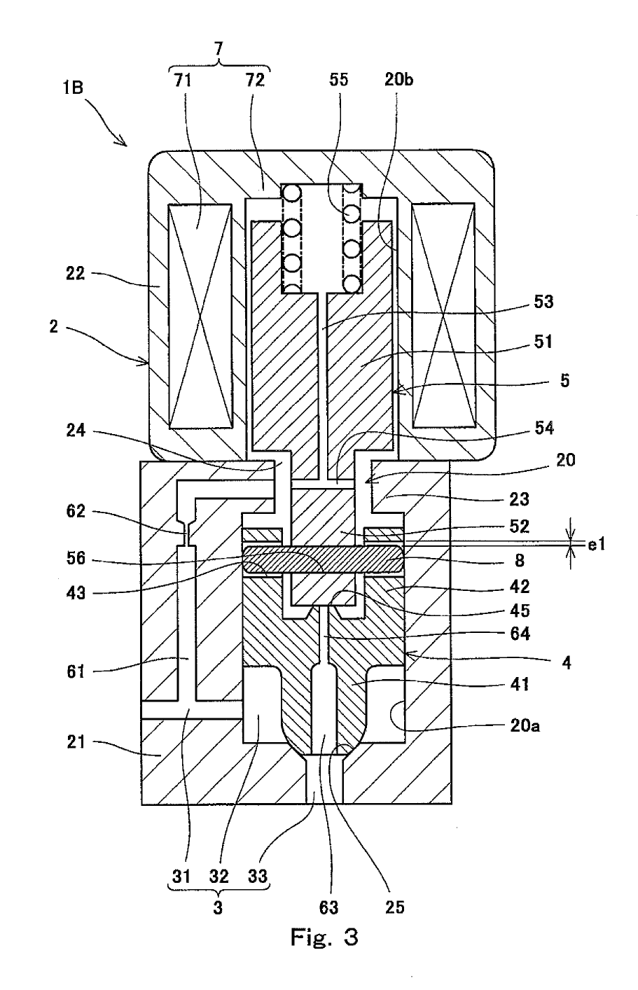

Next, a valve device 1B according to Embodiment 2 of the present invention will be explained in reference to FIG. 3. In the present embodiment and Embodiments 3 to 5 below, the same reference signs are used for the same components as in Embodiment 1, and a repetition of the same explanation is avoided.

In the present embodiment, the pin 8 is fitted in the transverse hole 56 of the pilot valve element 5 without any gap, and the gap e1 which allows the pilot valve element 5 to be separated from the main valve element 4 is formed between the support hole 43 of the main valve element 4 and the pin 8.

Embodiment 2 configured as above can obtain the same effects as Embodiment 1.

### Embodiment 3

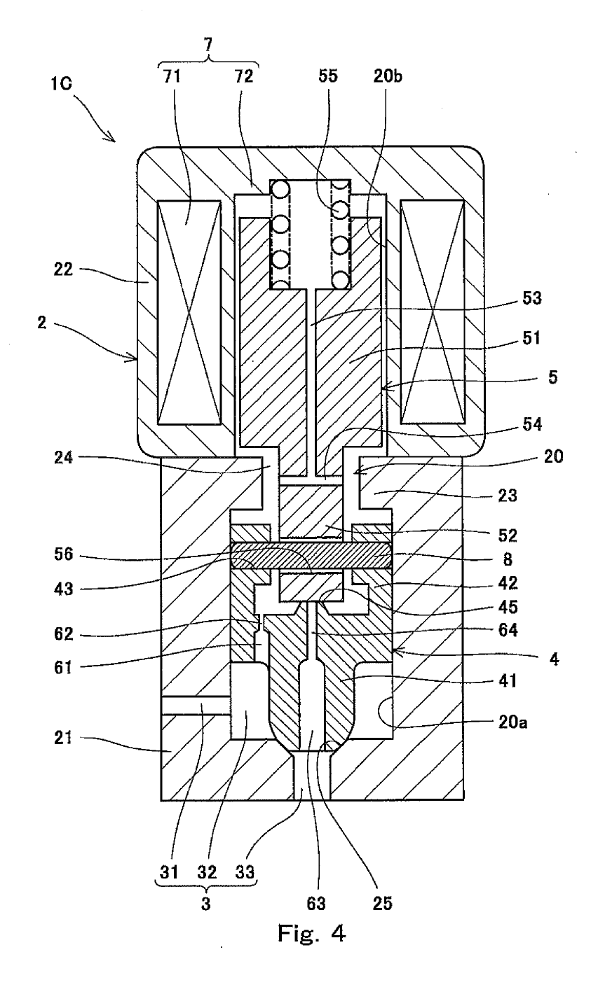

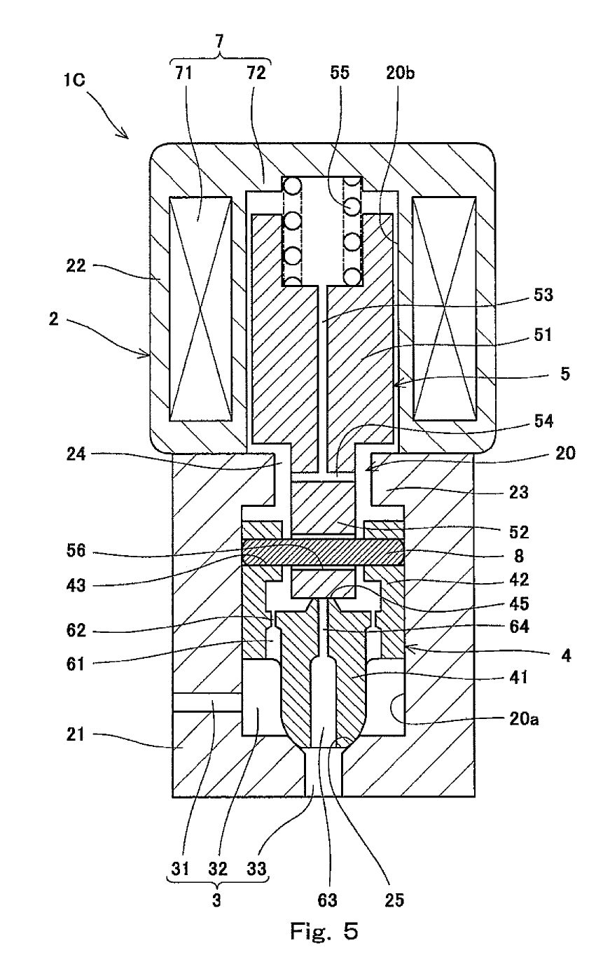

Next, a valve device 1C according to Embodiment 3 of the present invention will be explained in reference to FIG. 4. In the present embodiment, the first pilot passage 61 including the first restrictor 62 is formed at the main valve element 4, and the upstream end of the first pilot passage 61 indirectly communicates with the primary passage 31 through the first pressure chamber 32. As shown in FIG. 5, a plurality of first pilot passages 61 may be formed around the shaft portion 41 of the main valve element 4.

Embodiment 3 configured as above can obtain the same effects as Embodiment 1.

### Embodiment 4

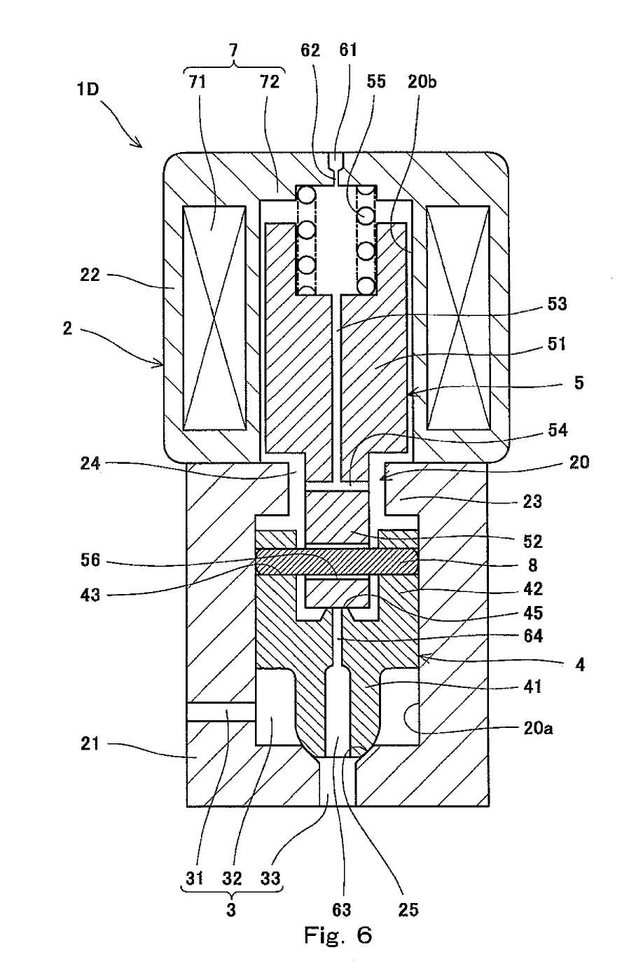

Next, a valve device 1D according to Embodiment 4 of the present invention will be explained in reference to FIG. 6. In the present embodiment, the first pilot passage 61 including the first restrictor 62 is formed at the fixed magnetic pole 72.

In the present embodiment, almost whole of the valve device 1D is assumed to be inserted into a gas tank (not shown). To be specific, the upstream end of the first pilot passage 61 indirectly communicates with the primary passage 31 through an internal space of the gas tank.

Embodiment 4 configured as above can obtain the same effects as Embodiment 1.

### Embodiment 5

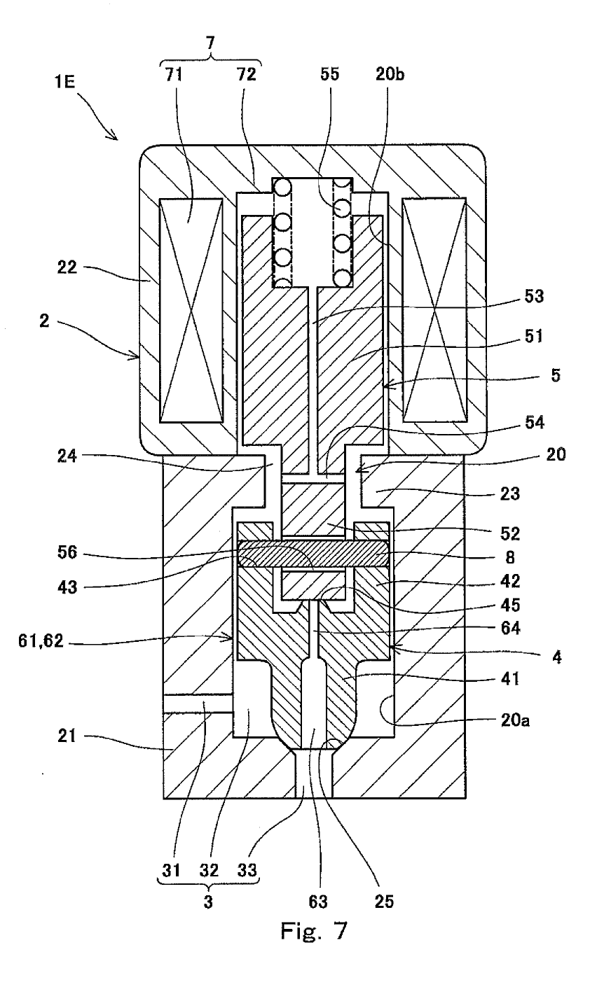

Next, a valve device 1E according to Embodiment 5 of the present invention will be explained in reference to FIG. 7. In the present embodiment, the outer diameter of the tubular portion 42 of the main valve element 4 is set to be slightly smaller than that in Embodiments 1 to 4, and the first pilot passage 61 is constituted by an annular gap between the main valve element 4 and the first sliding chamber 20a. The first pilot passage 61 serves as the first restrictor 62 over the entire length.

Embodiment 5 configured as above can obtain the same effects as Embodiment 1. Further, according to the present embodiment, the first pilot passage 61 and the first restrictor 62 can be simply configured at low cost. On the other hand, when the first pilot passage 61 is formed at the housing 2 or the main valve element 4 as in Embodiments 1 to 4, the first restrictor 62 can be formed by machine work with a high degree of accuracy.

The gap formed between the main valve element 4 and the first sliding chamber 20a and serving as both the first pilot passage 61 and the first restrictor 62 does not have to have an annular shape surrounding the main valve element 4 and may be constituted by one or a plurality of grooves formed on the outer peripheral surface of the tubular portion 42 of the main valve element 4.

### INDUSTRIAL APPLICABILITY

The present invention is widely applicable to valve devices for various uses.

### REFERENCE SIGNS LIST

1A to 1E valve device
2 housing
20 valve element space
23 stopper
24 second pressure chamber
3 main passage
31 primary passage
32 first pressure chamber
33 secondary passage
4 main valve element
5 pilot valve element
55 biasing member
61 first pilot passage
62 first restrictor
63 second pilot passage
64 second restrictor
7 solenoid
8 pin
e1 gap

1. A valve device comprising:
a housing including a primary passage, a secondary passage, and a valve element space between the primary passage and the secondary passage, the primary passage and the secondary passage constituting a main passage;
a main valve element provided in the housing so as to divide the valve element space into a first pressure chamber and a second pressure chamber, the main valve element being configured to open and close the secondary passage, the first pressure chamber communicating with the primary passage and the secondary passage;
a first pilot passage including one end directly or indirectly communicating with the primary passage, the other end communicating with the second pressure chamber, and a first restrictor;
a second pilot passage including a second restrictor and formed at the main valve element so as to extend from the second pressure chamber to the secondary passage;
a pilot valve element provided in the second pressure chamber and configured to open and close the second pilot passage;
a biasing member configured to press the pilot valve element against the main valve element;
a drive mechanism configured to, when a current flows through the drive mechanism, drive the pilot valve element such that the pilot valve element opens the second pilot passage against biasing force of the biasing member; and
a pin coupling the main valve element and the pilot valve element to each other, a gap which allows the pilot valve element to be separated from the main valve element being formed between the pin and the main valve element or between the pin and the pilot valve element, wherein
when the second pilot passage is opened by the pilot valve element, and pressure of the second pressure chamber becomes lower than pressure of the first pressure chamber, the main valve element is driven so as to open the secondary passage by differential pressure between the first pressure chamber and the second pressure chamber.

2. The valve device according to claim 1, wherein:
the drive mechanism is a solenoid including a fixed magnetic pole configured to attract the pilot valve element;
the housing is provided with a stopper for the main valve element; and
when the second pilot passage and the secondary passage are closed, a distance from the pilot valve element to the fixed magnetic pole is longer than a sum of a distance from the main valve element to the stopper and the gap.

3. The valve device according to claim 1, wherein the first pilot passage is formed at the housing or the main valve element.

4. The valve device according to claim 1, wherein:
the housing includes a sliding chamber configured to hold the main valve element such that the main valve element is slidable; and
the first pilot passage is a gap between the main valve element and the sliding chamber and serves as the first restrictor over an entire length of the first pilot passage.

5. The valve device according to claim 2, wherein the first pilot passage is formed at the housing or the main valve element.

6. The valve device according to claim 2, wherein:
the housing includes a sliding chamber configured to hold the main valve element such that the main valve element is slidable; and
the first pilot passage is a gap between the main valve element and the sliding chamber and serves as the first restrictor over an entire length of the first pilot passage.
